(19) United States
(12) Patent Application Publication
(10) Pub. No.: US 2012/0158991 A1
(43) Pub. Date: Jun. 21, 2012

(54) Mobile Device as a Relay Server in a Mobility Service Platform

(76) Inventors: Sandhya Rani Ajjaguttu, Anantapur (IN); Chandra Kumar Banavara Krishna Murthy, Bangalore (IN); Allan Perry Herrod, Mission Viejo, CA (US); Gnana Prasad Reddy B, Anantapur (IN)

(21) Appl. No.: 12/974,586

(22) Filed: Dec. 21, 2010

(51) Int. Cl. G06F 15/173

(52) U.S. Cl. 709/238

(57) ABSTRACT

A system includes a first mobile device and a second mobile device. The first mobile device has access to staging data of a network relay server. The second mobile device is precluded from connecting to the network relay server. The second mobile device is configured to connect to the first mobile device. The first mobile device is configured as a mobile relay server for transmitting the staging data to the second mobile device.

### BACKGROUND

In order for an electronic device to properly connect to a network, the device has to initially be configured to be managed and be discovered on the management system. Specifically, the device has to be staged that enables the configuration of the device. Staging is the process of quickly preparing mobile devices to get into an enterprise by providing settings to configure connectivity to the enterprise network, to configure access to a deployment server, and to specify the deployment to be performed. Thus, the electronic device is first required to obtain the requisite files for staging that requires the electronic device to connect to a network component such as a relay server.

There are many scenarios in which the electronic device may be incapable of reaching the relay server, thereby being precluded from being staged and, therefore, not being capable of configuration to the network. In a first scenario, the electronic device may not physically be capable of reaching the relay server. For example, the electronic device may not be in an operating area of the network. In another example, the electronic device may not include the requisite hardware to connect to the network. In a second scenario, the network may utilize a specified communications protocol that the electronic device is not configured. Thus, the electronic device may be precluded from exchanging data with the network despite being in an operating area of the network and including the necessary hardware.

### SUMMARY OF THE INVENTION

The present invention describes a system comprising a first mobile device and a second mobile device. The first mobile device has access to staging data of a network relay server. The second mobile device is precluded from connecting to the network relay server. The second mobile device is configured to connect to the first mobile device. The first mobile device is configured as a mobile relay server for transmitting the staging data to the second mobile device.

### DESCRIPTION OF THE DRAWINGS

FIG. 1 shows a network in which a first mobile device is connected thereto and acts as a relay server for a second mobile device not connected to the network according to an exemplary embodiment.

FIG. 2 shows a network in which a first mobile device is connected thereto and acts as a relay server for a second mobile device incapable of connecting to the network according to an exemplary embodiment.

FIG. 3 shows a method for enabling data exchange with a network using a first mobile device as a relay server for a second mobile device not connected to the network according to an exemplary embodiment.

FIG. 4 shows a method for enabling data exchange with a network using a first mobile device as a relay server for a second mobile device incapable of connecting to the network according to an exemplary embodiment.

### DETAILED DESCRIPTION

The exemplary embodiments may be further understood with reference to the following description and the appended drawings, wherein like elements are referred to with the same reference numerals. The exemplary embodiments describe a first mobile device configured to serve as a relay server for staging of a second mobile device. Specifically, an edge device of a network is configured as a relay server for staging of a further edge device. A first exemplary scenario is when the second mobile device is not physically capable of connecting to a network relay server but requires staging. A second exemplary scenario is when the second mobile device is not properly configured to communicate with the network but requires staging. The first and second mobile devices, the network, the first scenario, the second scenario, and related methods will be discussed in further detail below.

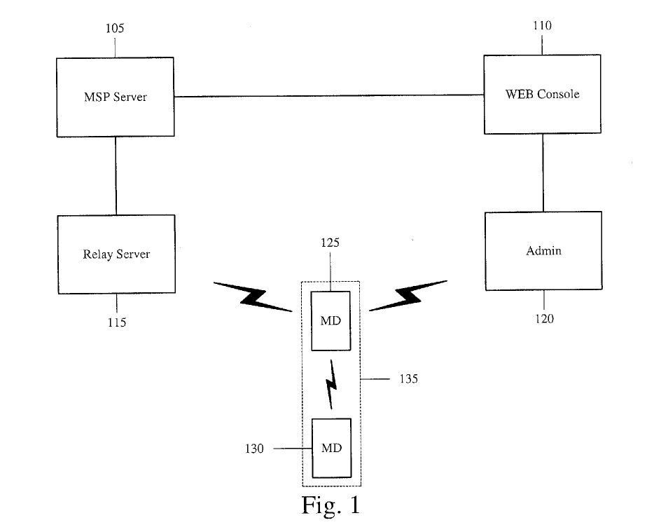

FIG. 1 shows a network in which a first mobile device 125 is connected thereto and acts as a mobile relay server for a second mobile device 130 not connected to the network according to an exemplary embodiment. The network may include a variety of network components providing conventional functionalities. As illustrated, the network may include a Mobility Services Platform (MSP) server 105, a WEB console 110, a relay server 115, and an administrator 120. The MSP server 105 may represent the central management system for the network that is in charge of managing wireless mobile devices such as mobile device 125. The MSP server 105 may include staging profiles for mobile devices of the network for staging purposes. The WEB console 110 may provide an interface for an administrator. The relay server 115 may be a network protocol used to copy a file from a host to another host using, for example, a transmission control protocol (TCP)/Internet protocol (IP) based network. Thus, the relay server 115 may provide the staging profiles of the MSP server 105 to the mobile devices of the network. It should be noted that the relay server 115 may use any transmission protocols for the exchange of data. The administrator 120 may indicate permission for data exchange such as controlling which end devices are allowed to receive or transmit data on the network.

It should be noted that the use of the mobile device is only exemplary. The mobile devices may represent any edge computing device. For example, a computing terminal that is configured with a wireless card may also utilize the exemplary embodiments. In another example, the mobile devices may generally represent any computing device that is capable of connecting to the network such as with a network cable. It should also be noted that the network components are only exemplary. That is, the network may include further components such as access points, network management assistants, signal boosters, etc.

It should also be noted that the use of the MSP server 105 is only exemplary. The MSP server 105 used herein may relate to any network component that is configured to provide the above described functionalities as the central management server of a network. According to the exemplary embodiments, the MSP server 105 may generally represent other central management servers such as Microsoft SCCM, SOTI MobiControl, Wavelink Avalanche, etc.

The relay server 115 may be an intermediate point for communications between the management server and the edge devices of the network. Specifically, when a staging profile is requested between the MSP server 105 and the mobile device 125, the relay server 115 may provide storage and transceiving functionalities when the staging profile is sent and/or when the request is received to/from the mobile device 125. The relay server 115 may be any network component that is configured to provide the functionalities as described above for the relay server 115. For example, the relay server 115 may be a file transfer protocol (FTP) server.

As illustrated in FIG. 1, the first mobile device 125 may be connected to the network (e.g., wired or wireless connection) and have access to at least the relay server 115 and the administrator 120. The first mobile device 125 is capable of data exchange with the network. Through the connection with the relay server 115, the first mobile device 125 may transmit a request for a staging profile to the relay server 115 (e.g., upstream protocol) or receive the staging profile from the relay server 115 (e.g., downstream protocol). Through the connection with the administrator 120, the first mobile device 125 may transmit identification data to enable transmission/reception of data, for example, with the relay server 115. Through the connection with the MSP server 105, the staging profile received by the first mobile device 125 may be sent to any other node on the network.

According to one of the exemplary embodiments, the second mobile device 130 may also be connected to the network via the first mobile device 125. As illustrated in FIG. 1, the second mobile device 130 may only be configured to be connected to the first mobile device 125. For example, the second mobile device 130 may be outside an operating area of the network but within range to establish wireless communications with the first mobile device 125. As discussed above, the second mobile device 130 may be connected to the first mobile device 125 using any means such as a wireless connection or a wired connection.

It should again be noted that the mobile devices 125, 130 may represent any electronic device that is capable of communications. Thus, the mobile devices 125, 130 may also represent terminals that are configured to connect to the network. It should also be noted that the mobile devices 125, 130 may include conventional components such as a processor, a memory, a display, a transceiver, etc.

The first mobile device 125 may be configured to act as a mobile relay server such as a file transfer protocol secure (FTPS) server that is an extension to relay server 115 functionalities and adds support for transport layer security (TLS) and secure sockets layer (SSL) cryptographic protocols. It should again be noted as with the relay server 115 that the use of the FTPS is only exemplary and any network component functionality that is assumed by the first mobile device 125 to provide data exchange may be used. Thus, when the second mobile device 130 connects to the first mobile device 125, the second mobile device 130 is capable of data exchange with the network to receive a staging profile. A connection 135 that is established between the mobile devices may be a device to device management connection such as a peer to peer (P2P) or may be an ad hoc connection. As a mobile relay server, the first mobile device 125 may forward a request for a staging profile from the second mobile device 130. The first mobile device 125 may thereby act as a bridge for the second mobile device 130 to the relay server 115. In another example, the first mobile device 125 may extend the functionalities of the MSP server 105 and the relay server 115, thereby enabling the second mobile device 130 to be staged. Specifically, the first mobile device 125 may include the requested data for the staging profile. For example, the first mobile device 125 may have the staging profile stored locally. The first mobile device 125 may have stored the staging profile locally from being staged previously, storing the staging profile preemptively due to its role as the mobile relay server, etc.

It should be noted that when the first mobile device 125 acts as a bridge for the staging profile, the storing of data on the first mobile device 125 may occur but is only exemplary. Although a temporary storage may occur whenever data is retrieved by the first mobile device 125, the connection between the mobile devices may enable a live transmission so that the staging profile received by the first mobile device 125 from the relay server 115 and requested by the second mobile device 130 may be directly received by the second mobile device 130.

The first mobile device 125 may serve as a relay server in a variety of manners. As discussed above in a first example, the first mobile device 125 may permanently store predetermined staging profiles. Thus, the first mobile device 125 may be configured to provide requested data from the second mobile device 130 directly from a storage disposed on the first mobile device 125, thereby not requiring data stored in the relay server 115. For example, the first mobile device 125 may store a plurality of staging profiles, one that may be requested by the second mobile device 130. If the first mobile device 125 already has the staging profile stored thereon, the second mobile device 130 may receive the staging profile data directly from the first mobile device 125. Also as discussed above in a second example, the first mobile device 125 may act as an on-demand bridge to the relay server 115, thus getting a requested staging profile from the relay server 115 and forwarding it to the requesting second mobile device 130 without storing the data.

As discussed above, the relay server functionality of the first mobile device 125 may be configured as a FTPS. Thus, security issues of relay server 115 may be addressed. In a first example, the second mobile device 130 may transmit identification data to the first mobile device 125 which forwards the identification data to the administrator 120. The first mobile device 125 may receive permission data relating to the second mobile device 130. The permission data may also indicate the staging profiles permitted for the second mobile device 130. In a second example, the FTPS functionality may include permission data. Thus, the first mobile device 125 may access the permission data that relates to the second mobile device 125. When the second mobile device 130 requests a staging profile, the FTPS may determine whether the second mobile device 130 is permitted access to the requested data.

It should be noted that the first mobile device 125 acting as the only device configured with the mobile relay server for the second mobile device 130 is only exemplary. According to the exemplary embodiments, the first mobile device 125 may provide the relay server functionalities for multiple mobile devices that are not configured to connect to the relay server 115. Furthermore, the second mobile device 130 may connect to multiple mobile devices that are configured as a relay server such as the first mobile device 130. For example, the network may include a plurality of mobile devices that have an established connection with the relay server 115. Furthermore, the plurality of mobile devices may include the relay server functionality as described above with the first mobile device 125. The second mobile device 130 may be in communications range of two or more of the mobile devices. Thus, the second mobile device 130 may exchange data with the two or more devices. In this manner, a higher probability of a successful data exchange may be accomplished. For example, multiple mobile devices connected to the relay server 115 may receive a portion of the staging profile to provide to the second mobile device to decrease a time for the second mobile device 130 to receive a whole staging profile. In another example, an increased probability exists that at least one of the mobile devices that the second mobile device 130 is connected includes a locally stored requested staging profile.

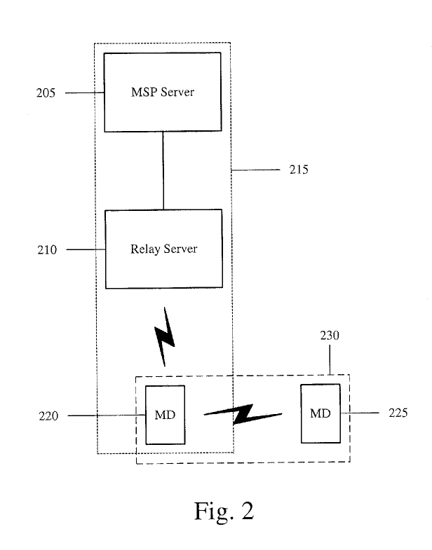

FIG. 2 shows a network in which a first mobile device 220 is connected thereto and acts as a relay server for a second mobile device 225 incapable of connecting to the network according to an exemplary embodiment. As discussed with respect to FIG. 1, the network may include a variety of network components providing conventional functionalities. As illustrated, a MSP server 205 and a relay server 210 are shown as network components. However, as noted above, the network may include other components.

As illustrated in FIG. 2, the first mobile device 220 may be connected to the network and have access to at least the MSP server 205 and the relay server 210. The first mobile device 220 is capable of data exchange with the network, in particular to receive a staging profile that is requested by the second mobile device 225. According to this exemplary embodiment, the network and the first mobile device 220 may be configured with a common wireless communications protocol to enable the data exchange. Thus, a connection 215 may be established between the MSP server 205, the relay server 210, and the first mobile device 220. As discussed above, the connection between the network and the first mobile device 220 may be a wired and/or a wireless connection.

According to one of the exemplary embodiments, the second mobile device 225 may also be connected to the network via the first mobile device 220 to receive a staging profile. As illustrated in FIG. 2, the second mobile device 225 may only be configured to be connected to the first mobile device 220. For example, the second mobile device 225 may be within an operating area of the network but not properly configured for wireless communications with the network such as not being configured with the wireless communications protocol(s) available for the network. As discussed above, the connection between the first mobile device 220 and the second mobile device 225 may be a wired and/or a wireless connection.

The first mobile device 220 may be configured to act as a mobile relay server in this exemplary embodiment as well. As discussed above, the mobile relay server may be a FTPS but being a FTPS is only exemplary. According to this exemplary embodiment, the first mobile device 220 may be configured with at least two communications protocols, the first to enable data exchange with the network and the second to enable data exchange with the second mobile device 225. Thus, a connection 230 may be established between the mobile devices. As discussed above, the connection 230 that is established between the mobile device may be a device to device management connection.

The functionality of the first mobile device 220 being a relay server provides many different features. For example, the first mobile device 220 may be a staging profile server. Thus, through the connection 230, the second mobile device 225 may be configured with its wireless communications protocol. However, should the first mobile device 220 not be configured with the relay server functionality, the second mobile device 225 is required to reach, for example, the relay server 210 on its own. Should the network not be configured with the wireless communications protocol of the second mobile device 225, the staging of the second mobile device 225 fails. However, since the first mobile device 220 is configured as a relay server, the second mobile device 225 may be properly staged. When the second mobile device 225 cannot reach the network, the first mobile device 220 is required to hold all required staging content for the second mobile device 225. Accordingly, the first mobile device 220 may cause a double footprint as it stores uninstalled and installed packages in memory concurrently. However, since the first mobile device 220 is configured as a relay server, the first mobile device 220 may provide a bridge for the second mobile device 225 over the P2P connection, thereby enabling the second mobile device 225 to be staged in the field despite not directly reaching the network. Therefore, as discussed above, the first mobile device 220 may provide the bridge for the second mobile device 225 to receive the staging profile from the relay server 210 or may receive the staging profile directly from the first mobile device 220 when the staging profile is stored locally.

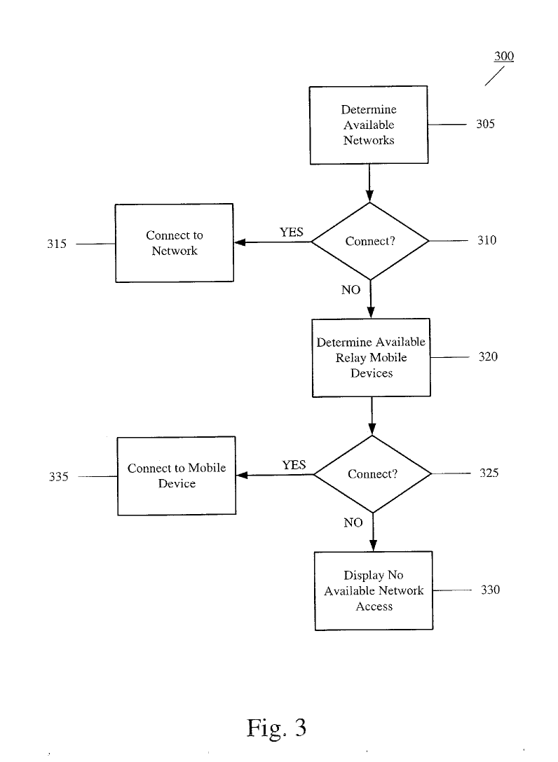

FIG. 3 shows a method 300 for enabling data exchange with a network using the first mobile device 125 as a relay server for the second mobile device 130 not connected to the network according to an exemplary embodiment. Specifically, the data exchange entails the second mobile device 130 receiving a staging profile from the first mobile device 125. The method 300 will be described with reference to FIG. 1. The method 300 will also be described with reference to the second mobile device 130.

In step 305, the second mobile device 130 determines available networks. That is, the second mobile device 130 may perform a scan to determine any networks that have an operating area in which the second mobile device 130 is disposed. The determination may indicate the networks that may also be available according to the wireless communications protocol(s) that the second mobile device 130 is configured. It should be noted that this step assumes that the second mobile device 130 includes the necessary hardware components to perform the search. As discussed above, should the second mobile device 130 not be configured with the hardware components, this step may be skipped.

In step 310, a determination is made whether a connection to one of the found networks is made. For example, if the scan indicates a desired network and the second mobile device 130 is configured to connect thereto, the method 300 continues to step 315 where a connection is made.

If the desired network is not found, the method 300 continues to step 320. In step 320, the second mobile device 130 determines available relay mobile devices. That is, the second mobile device 130 determines if any mobile devices are in wireless communications range of the second mobile device 130 and is also configured as a relay server. The determination may indicate the mobile devices that may also be available according to the wireless communications protocol(s) that the second mobile device 130 is configured. As discussed above with reference to FIG. 1, the first mobile device 125 may be configured as a mobile relay server and may also be configured to enable data exchange with the second mobile device 130 by having a common wireless communications protocol. It should be noted that, as discussed above, the second mobile device 130 may be connected to the first mobile device with a wired connection. In such a scenario, this step may also be skipped.

In step 325, a determination is made whether a connection to one of the found relay mobile devices is made. For example, if the scan indicates a desired relay mobile device and the second mobile device 130 is configured to connect thereto, the method 300 continues to step 335 where a connection is made. Once the connection 135 is established, the second mobile device 130 may be connected to the network via the first mobile device 125 to enable data exchange. Specifically, the first mobile device 125 may act as a bridge for the second mobile device 130 to receive a staging profile from the relay server 115. If the scan indicates no relay mobile devices, the method 300 continues to step 330 where a display is shown that indicates no available network access. That is, the second mobile device 130 is not in an operating area of the network and/or a mobile device configured to act as a relay server. As discussed above, the second mobile device 130 may connect to multiple mobile relay servers. Also as discussed above, in the scenario where the first mobile device 125 locally stores the staging profile, the connection established in step 335 may enable the second mobile device 130 to receive the staging profile directly from the first mobile device 125.

It should be noted that the method 300 may include further steps. For example, if the scan of step 320 indicates a list of available relay mobile devices but the relay server functionality is not initiated, the second mobile device 130 may send a request to the first mobile device 125 to activate the relay server functionality. In another example, if the scan of step 320 indicates a list of available mobile devices, the second mobile device 130 may send a request to the first mobile device 125 to indicate whether the relay server functionality is available. If the functionality is available on the first mobile device 125, the request may subsequently be sent from the second mobile device 130.

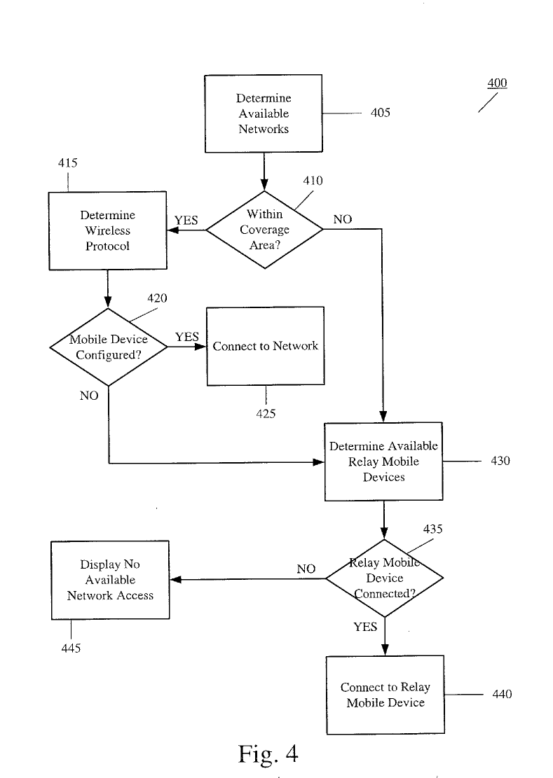

FIG. 4 shows a method 400 for enabling data exchange with a network using the first mobile device 220 as a relay server for the second mobile device 225 incapable of connecting to the network according to an exemplary embodiment. Specifically, the data exchange entails the second mobile device 225 receiving a staging profile from the first mobile device 220. The method 400 will be described with reference to FIG. 2. The method 400 will also be described with reference to the second mobile device 225.

In step 405, the second mobile device 225 determines available networks. In a substantially similar manner as step 305 of method 300, the second mobile device 225 may perform a scan to determine any networks that have an operating area in which the second mobile device 225 is disposed. As discussed above, should the second mobile device 225 not be configured with the hardware components, this step may be skipped.

In step 410, a determination is made whether the second mobile device 225 is within an operating area of a desired network. Thus, if the scan from step 405 indicates that the desired network includes an operating area in which the second mobile device 225 is disposed, the method 400 continues to step 415. If the second mobile device 225 is outside the operating area of the desired network, the method 400 continues to step 430 in which a substantially similar process as method 300 continues.

In step 415, the wireless communications protocol of the desired network is determined. For example, the second mobile device 225 may attempt to ping the network using its own wireless communications protocol(s). If no response is received, the second mobile device 225 may assume that the network operates using a wireless communications protocol that the second mobile device 225 is not configured.

In step 420, a determination is made whether the second mobile device 225 is configured with the wireless communications protocol of the network. If the second mobile device 225 is configured with the wireless communications protocol of the network, the method 400 continues to step 425 where the second mobile device 225 connects to the network. If the second mobile device 225 is not configured with the wireless communications protocol of the network, the method 400 continues to step 430.

In step 430, the second mobile device 225 determines available relay mobile devices. That is, the second mobile device 225 determines if any mobile devices are in wireless communications range of the second mobile device 225 and is also configured as a mobile relay server. As discussed above with reference to FIG. 2, the first mobile device 220 may be configured as a relay server and may also be configured to enable data exchange with the second mobile device 225 by having a common wireless communications protocol.

In step 435, a determination is made whether the relay mobile device (e.g., first mobile device 220) is connected to the desired network. For example, the first mobile device 220 may be configured to act as a relay server but may currently not be connected to the network. If the first mobile device 220 is not connected to the network, the second mobile device 225 may request connection to the network so that a subsequent connection 230 may be established to enable the second mobile device 225 to also connect to the network. Thus, in step 440, if the relay mobile device is connected to the network, the second mobile device 225 may request connection to the first mobile device 220. If the second mobile device 225 is incapable of connecting to the network and no relay mobile devices are within range of the second mobile device 225, the method 400 continues to step 445 where a display is shown that indicates no available network access. As discussed above, the second mobile device 225 may connect to multiple mobile relay servers. It should again be noted that in the scenario where the first mobile device 220 locally stores the staging profile, the connection established in step 440 may enable the second mobile device 225 to receive the staging profile directly from the first mobile device 220.

The exemplary embodiments provide a mobile relay server to enable a mobile device that is otherwise incapable of connecting to a network relay server to establish a connection with the mobile relay server, thereby capable of receiving a staging profile for the network. Specifically, the mobile relay server may be a further mobile device configured to perform the functionalities of a relay server by establishing a connection with the mobile device. For example, if the mobile device is not within an operating area of the network but is within an operating area of the mobile relay server, the mobile device may receive the staging profile for the network via the mobile relay server. In another example, if the mobile device is not configured with a wireless communications protocol of the network but is configured with a wireless communications protocol of the mobile relay server and the mobile relay server is also configured with the wireless communications protocol of the network, the mobile device may receive the staging profile for the network via the mobile relay server. There may be other examples of why the mobile device may not connected directly to the network relay server and would require the mobile relay server such as the mobile device may be designed specifically as a slave device to the mobile relay server device, the device may be low on power and communicating with the relay server device may require less power, etc.

Thus, the mobile device may be able to perform a data exchange with the network by the mobile relay server that extends the functionalities of a MSP server and/or a relay server. The mobile relay server may also be a FTPS to provide security measures to ensure that the mobile device is not inadvertently allowed to exchange data that is otherwise not available to the mobile device. By having the mobile relay server provide the functionalities described above, the server of the network that would otherwise be utilized may be offloaded to the relay server instead.

Those skilled in the art will understand that the above described exemplary embodiments may be implemented in any number of manners, including, as a separate software module, as a combination of hardware and software, etc. For example, the relay server functionality of the first mobile device may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a first mobile device having access to staging data of a network relay server; and
a second mobile device precluded from connecting to the network relay server, the second mobile device configured to connect to the first mobile device, the first mobile device configured as a mobile relay server for transmitting the staging data to the second mobile device.

2. The system of claim 1, wherein the second mobile device is disposed outside an operating area of the network.

3. The system of claim 2, wherein the second mobile device is connected to the first mobile device via one of a wired connection and a wireless connection.

4. The system of claim 1, wherein the second mobile device is disposed within an operating area of the first mobile device.

5. The system of claim 4, wherein the first mobile device is configured with a first and a second communications protocol, the first communications protocol enabling the access to the network relay server, the second communications protocol enabling the connection to the second mobile device.

6. The system of claim 1, wherein the first mobile device further comprises a memory that locally stores the staging data prior to exchange with the second mobile device.

7. The system of claim 6, wherein the second mobile device receives the staging data directly from the first mobile device.

8. The system of claim 7, wherein the first mobile device is precluded from connecting to the network relay server.

9. The system of claim 1, wherein the first mobile device acts as a bridge so that the second mobile device receives the staging data from the network relay server.

10. A mobile device, comprising:
a processor;
a memory; and
a transceiver configured to receive staging data from a network relay server,
wherein the mobile device is configured as a mobile relay server for transmitting the staging data to a further mobile device, the mobile device configured to connect to the further mobile device that is precluded from connecting to the network relay server.

11. The mobile device of claim 10, wherein the memory locally stores the staging data prior to exchange with the further mobile device.

12. The mobile device of claim 11, wherein the further mobile device receives the staging data directly from the mobile device.

13. The mobile device of claim 10, wherein the mobile device is configured with a first and a second communications protocol, the first communications protocol enabling the access to the network relay server, the second communications protocol enabling the connection to the further mobile device.

14. The mobile device of claim 13, wherein the further mobile device is disposed within a coverage area of the network.

15. The mobile device of claim 10, wherein the mobile device acts as a bridge so that the further mobile device receives the staging data from the network relay server.

16. A mobile device, comprising:
a processor;
a memory; and
a transceiver configured to connect to a further mobile device, the transceiver precluded from connecting to a network relay server,
wherein the further mobile device is configured as a mobile relay server having access to staging data of the network relay server.

17. The device of claim 16, wherein the mobile device initially determines a plurality of further mobile devices configured to access the staging data.

18. The device of claim 17, wherein the mobile device sends a query indicating whether the further mobile device locally stored the staging data.

19. The device of claim 18, wherein the mobile device sends a request to at least one of the further mobile devices to transmit the staging data.

20. The device of claim 17, wherein the mobile device sends a request to at least one of the further mobile devices to act as a bridge to receive the staging data from the network relay server.
